(19) United States
(12) Patent Application Publication
(10) Pub. No.: US 2010/0170579 A1
(43) Pub. Date: Jul. 8, 2010

(54) QUICK RELEASE DEVICE FOR FAUCETS

(76) Inventor: Faucet WU, Changhua (TW)

Correspondence Address: SINORICA, LLC, 2275 Research Blvd., Suite 500, ROCKVILLE, MD, 20850, US

(21) Appl. No.: 12/349,537

(22) Filed: Jan. 7, 2009

(51) Int. Cl. F16K 21/00

(52) U.S. Cl. 137/315.01

(57) ABSTRACT

A quick release device for faucets mainly includes a valve and a quick release unit. The valve is connected to at least two passages through which water flows, at least one passage is formed with a concave joint slot the inner circumference of which is formed with a shift limit slot. The quick release joint unit is oppositely arranged in the joint slot, and a shift limit unit is provided in the quick release joint and may be thereby fixed in the shift limit slot. A pipeline is provided that may be quickly installed on and removed from the quick release joint group. Thus, the installation time may be saved, the complicated installation steps may be reduced, and the area where flowing water contacts the metal may be decreased.

### BACKGROUND OF THE INVENTION

1. Field of the Invention

This invention relates to a quick release device for faucets.

2. Description of the Related Art

A conventional faucet is provided with a valve. The valve is connected to two passages the outer circumference of which is formed with threads that are used to spirally fix a water inlet pipeline and a water outlet pipeline, and the water outlet is controlled by the valve.

However, in the manner of spiral fixing, it takes more time and is inconvenient to remove and install the conventional faucet, and a tool is required for installation. Further, in the valve, the water current and the metal surface contact area are larger; the larger the contact surface area is, the easier the metallic substances are brought; excessive remaining metals does harm to human body.

Consequently, because of the technical defects of described above, the applicant keeps on carving unflaggingly through wholehearted experience and research to develop the present invention, which can effectively improve the defects described above.

### SUMMARY OF THE INVENTION

A quick release device for faucets according to this invention mainly comprises a valve and a quick release unit. The valve is connected to at least two passages through which water flows, at least one passage is formed with a concave joint slot the inner circumference of which is formed with a shift limit slot. The quick release joint group is correspondingly arranged in the joint slot, and a shift limit unit is provided around the outer circumference of quick release joint and may thereby fixed in the shift limit slot. A watertight unit is provided between the joint slot and the quick release joint group to prevent water leakage. A pipeline is provided that may be quickly installed on and removed from the quick release joint group.

Regarding the quick release device for faucets, only the pipeline passes through the quick release joint unit and the watertight unit for completion of installation, which saves installation time, reduces complicated installation steps, decreases the area where flowing water contacts the metal, and lower the metal precipitation.

### BRIEF DESCRIPTION OF THE DRAWINGS

FIG. 1 is a partial 3D exploded perspective view of a lavatory faucet with two lever handles;

FIG. 2 is a partial 3D exploded perspective view of a water inlet passage of the lavatory faucet with two lever handles;

FIG. 3 is a 3D exploded view of a quick release joint unit of the lavatory faucet with two lever handles;

FIG. 4 is a partial 3D exploded perspective view of a widespread lavatory faucet with two lever handles;

FIG. 5 is a partial 3D exploded perspective view of a single-handle kitchen faucet;

FIG. 6 is a front perspective view of a tub and shower faucet with a single handle according to this invention;

FIG. 7 is a partial 3D exploded perspective view of a single-handle washer machine valve according to this invention;

FIG. 8 is a partial 3D exploded perspective view of a laundry faucet with two wrist blade handles according to this invention; and

FIG. 9 is a partial 3D exploded view of a washing machine faucet with two single control valves according to this invention.

### DETAILED DESCRIPTION OF THE PREFERRED EMBODIMENTS

Now, the present invention will be described more specifically with reference to the following embodiments. It is to be noted that the following descriptions of preferred embodiments of this invention are presented herein for purpose of illustration and description only; it is not intended to be exhaustive or to be limited to the precise form disclosed.

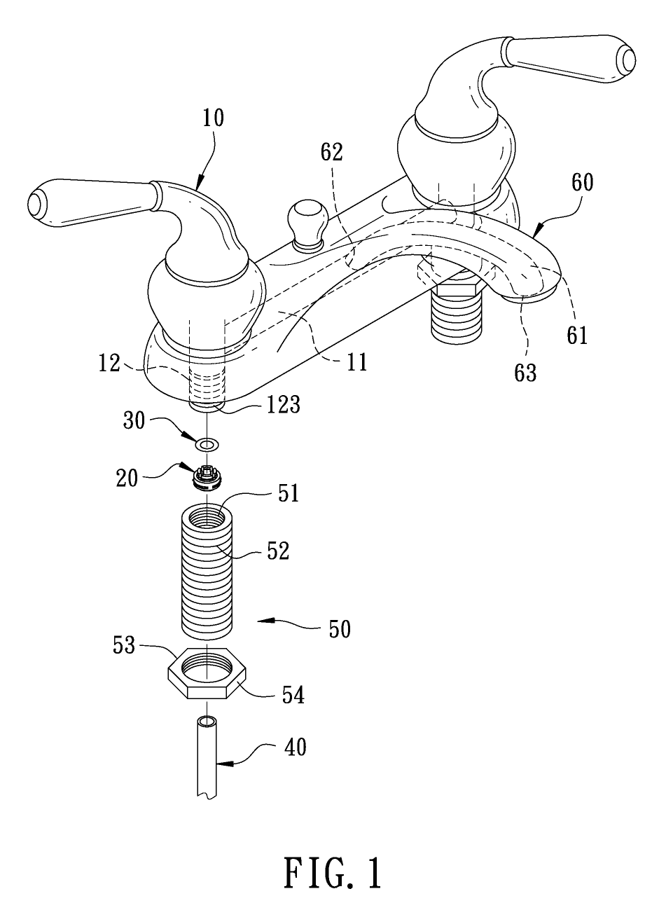

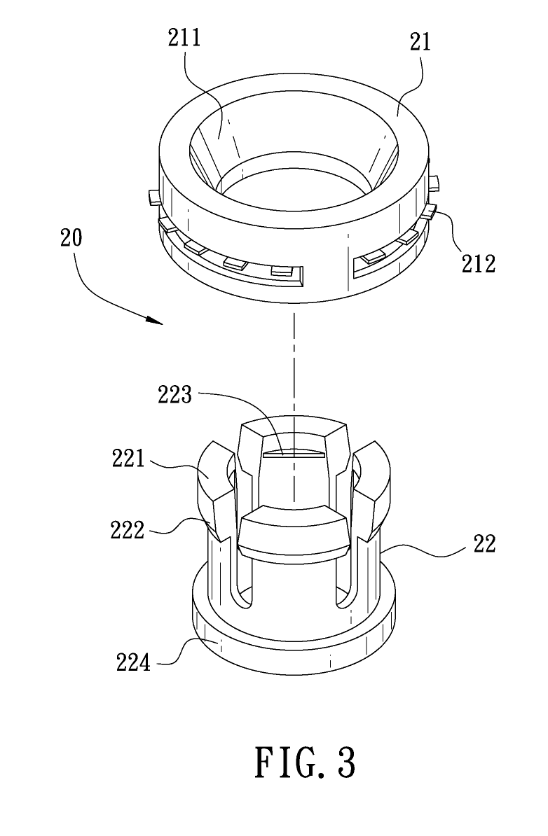

With reference to FIGS. 1, 2, and 3 shown respectively as a partial 3D exploded perspective view of a lavatory faucet with two lever handles, a partial 3D exploded perspective view of a water inlet passage, and a 3D exploded view of a quick release joint unit, the lavatory faucet with two lever handles mainly comprises a faucet body 60, two valves 10, two quick release joint units 20, two watertight units 30, two water pipes 40, and two joint units 50.

A gateway 61 is formed in the faucet body 60, and a water inlet 62 and a water outlet 63 are formed at the outside of faucet body 60 that is opposite to two ends of the gateway 61.

Each of the two valves 10 is connected to a water outlet passage 11 and a water inlet passage 12. The water outlet passages 11 are connected to a water inlet 62 of the faucet body 60. The outsides of water inlet passages 12 are formed with threads 123, the water passages 12 are concave and then formed with a joint slot 121. A shift limit slot 122 is formed around the inner circumference of each of the joint slots 121.

The quick release joint unit 20 is correspondingly arranged in the joint slot 121 and comprises an outer ring 21 and a locking jaw 22. The outer ring 21 is set around the outside of locking jaw 22, and the inner circumferential side of outer ring 21 is an inclined plane 211. Further, the outer circumference of outer ring 21 is formed with several protruding clamping slices 212 spaced at a distance of intervals and fixed in the shift limit slot 122. The locking jaw 22 has four chucks 221. Next, each of the outsides of chucks 221 is formed with a flange 222, and several shift limit slices 223 opposite to the flanges 222 are formed at the inner sides of chucks 221. A shift limit ring 224 is provided at the bottom side of locking jaw 22. The outer ring 21 pivots between the flange 222 and the shift limit ring 224.

The watertight units 30 are watertight O-rings that are provided between the joint slots 121 and the quick release joint units 20.

The water pipes 40 are plastic hoses one end of each of which is arranged in the quick release joint units 20.

The two joint units 50 are hollow pipes the inner sides of which are formed with inner threads 51 spirally adjoining the threads 123 of the water inlet passages 12. Each of the outsides of joint units 50 is further formed with outer threads 52 and spirally joined with a blockage unit 53, a screw nut 54, and the joint units 50 are used to fix the faucet to washbasin.

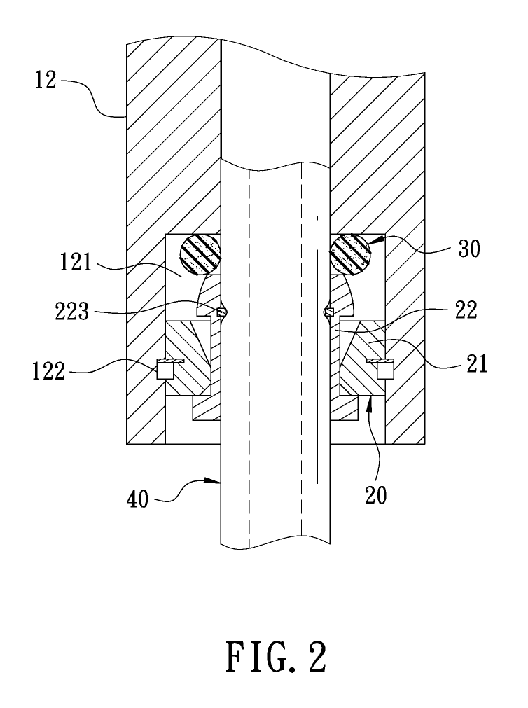

With reference to FIGS. 1 and 2, when the faucet is installed, only the water pipe 40 is required to pass through the quick release joint unit 20 and the watertight unit 30, thereby the connection procedure being finished. When the water pipe 40 is outwards pulled by a force, because the outer ring 21 is fixed into the joint slot 121, the locking jaw 22 that is subject to the friction withdraws from the outer ring 21 with the water pipe 40. Being subject to the shift limit of inclined plane 211 on the outer ring 21, the flange 222 on the chuck 221 makes the chuck 221 cause a force of grip, which makes the shift limit slice 223 in the chuck 221 fix the water pipe 40 and thus makes the water pipe 40 not fall off; for example, to remove the water pipe 40, the locking jaw 22 is upwards pushed to prevent the locking jaw 22 from withdrawing with the water pipe 40 and thus eliminate the force of grip that is caused by the chuck 221 on the water pipe 40. Thus, the pipeline of faucet may quickly removed without any tool. The water pipe 40 is made of plastics so that the lead content in water may be effectively lowered to increase the quality of water for the security of water use.

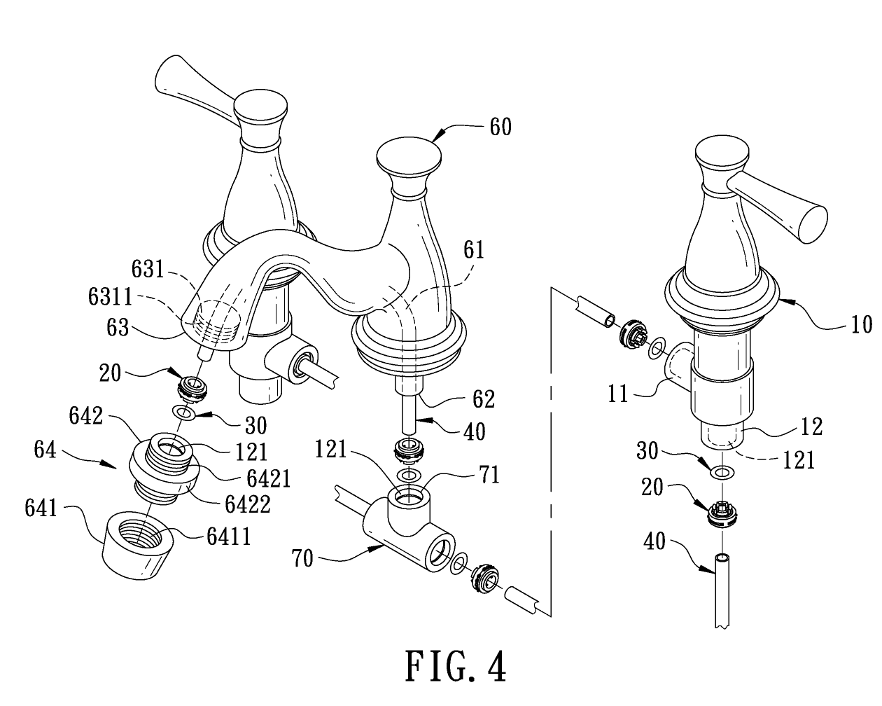

With reference to FIG. 4 shown as a partial 3D exploded perspective view of a widespread lavatory faucet with two lever handles, the faucet mainly comprises a faucet body 60, a bubbler unit 65, two valves 10, and a t-joint 70.

A gateway 61 is formed in the faucet body 60. A water inlet 62 and a water outlet 63 are formed at two ends of the gateway 61. A concave slot 64 is formed in the water outlet 63. Threads 641 are formed around the inner circumference of slot 64.

The bubbler unit 65 is oppositely provided in the slot 64, comprising a bubbler head 651 the inside of which is formed with threads 6511; and an adapter 652 in the form of a hollow pipe, the outside of which is formed with threads 6521 and the center of which is formed with a clamping ring 6522 arranged around. The two ends of adapter 652 respectively adjoin the threads 641 of slot 64 and the threads 6511 of bubbler head 651. On the portion spirally connected to the slot 64, the adapter 652 is further provided with a concave joint slot 121 to wedge to a watertight unit 30 and a quick release joint unit 20.

Each of the two valves 10 is connected to a water outlet passage 11 and a water inlet passage 12, in which a concave joint slot 121 is formed in the water outlet passage 11 and the water inlet passage 12 to wedge to a watertight unit 30 and a quick release joint unit 20, the two water pipes 40 are respectively connected to the quick release joint unit 20, and the other end of each of the water pipes 40 is connected to a water source.

The t-joint 70 is provided with three junction ports 71. A concave joint slot 121 is formed in each of the junction ports 71 to wedge to a watertight unit 30 and a quick release joint unit 20. Three water pipes 40 are provided that are respectively connected to the quick release joint unit 20. One end of the water pipe 40 that is connected to the junction ports 71 of the left and right ends of t-joint 70 is connected to the water outlet passages 11 of valves 10; the other end of the water pipe 40 that is connected to the junction port 71 at the top end of t-joint 70 passes through the water inlet 62 and connects to the quick release unit 20 of the adapter 652.

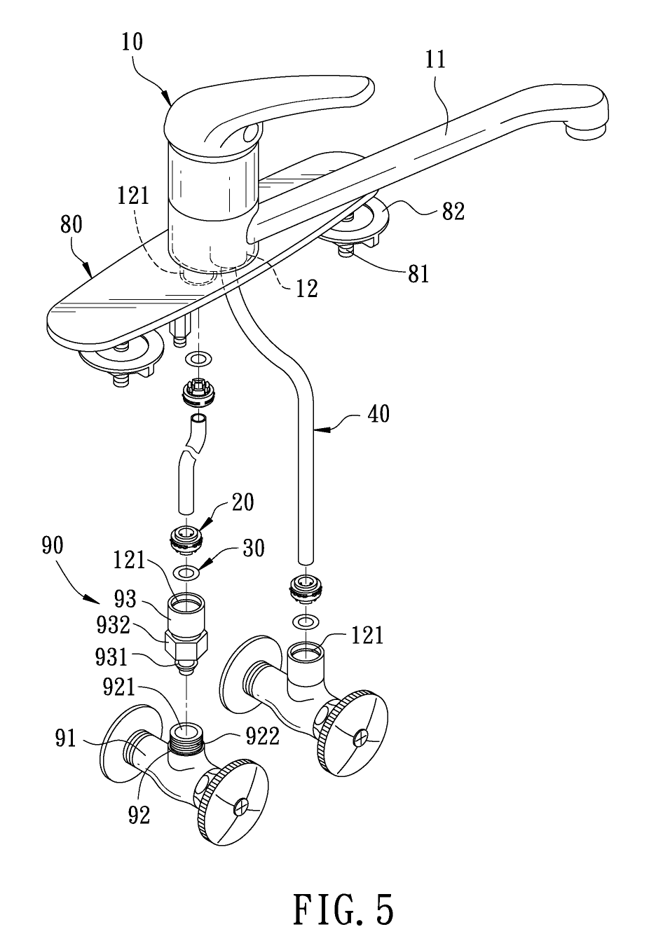

With reference to FIG. 5 shown as a partial 3D exploded perspective view of a single-handle kitchen faucet, the faucet mainly comprises a valve 10, two triangular valve 90, two adapter mounts 93, and two water pipes 40.

The valve 10 is locked onto a plate 80 and connected to a water outlet passage 11 and two water inlet passages 12. A concave joint slot 121 is formed in each of the water inlet passages 12 to wedge to a watertight unit 30 and a quick release joint unit 20.

The two triangular valves 90 are each connected to a water inlet passage 91 and a water outlet passage 92. The other end of each of the water inlet passages 91 is connected to a water source. A concave groove 921 is formed in each of the water outlet passages 92, and threads 922 are formed at the outside of each of the water outlet passages 92.

The two adapter mounts 93 are oppositely arranged in grooves 921 of the water outlet passages 92. A watertight portion 931 is provided around one side of each of the adapter mounts 93 and wedges to the groove 921 to prevent water leakage. A screw nut 932 is provided around the middle of each of the adapter mounts 93 and spirally adjoin the threads 922 of water outlet passage 92 to fix the adapter mount 93 onto the triangular valve 90. A concave joint slot 121 is formed at the other side of each of the junction ports 93 to wedge to a watertight unit 30 and a quick release joint unit 20.

Alternatively, in the triangular valve 90 that may be provided with no adapter mount 93, a concave joint slot 121 is directly formed in the water outlet passage 92 to wedge to a watertight unit 30 and a quick release joint unit 20.

The two ends of the two water pipes 40 are respectively connected to the quick release joint unit 20 on the adapter mount 93 and to that on the water inlet passage 12 of valve 10.

Thus, with valve control, water may be made to enter from the water inlet passage 91 and flow through the water pipe 40 and flow out of the water outlet passage 11. Further, a screw bolt 81 is provided at two inner sides of the plate 80, and a blocking flake 82 is spirally connected. Thus, the faucet in the embodiment may be fixed onto a kitchen counter.

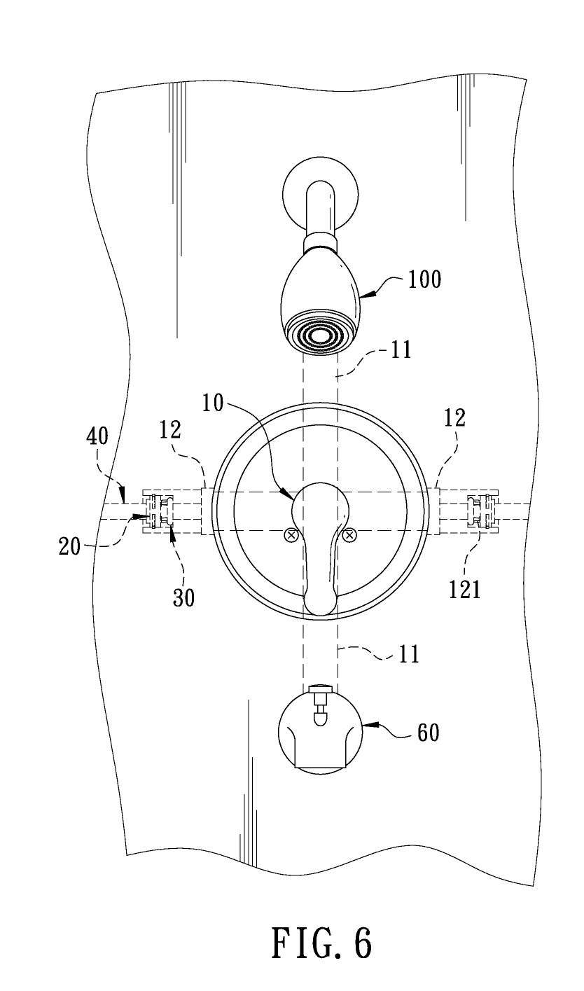

With reference to FIG. 6 shown as a front perspective view of a tub and shower faucet with a single handle according to this invention, the faucet mainly comprises a valve 10. The valve 10 is provided with two water outlet passages 11 and two water inlet passages 12. The other end of each of the water outlet passages 11 is connected to the faucet body 60 and the showerhead 100. A concave joint slot 121 is formed in each of the water inlet passages 12 to wedge to a watertight unit 30 and a quick release joint unit 20. The two water pipes 40 are connected to the quick release joint units 20, while the other end of each of the water pipes 40 is connected to a water source. Thus, being controlled by the valve 10, water is made to flow out of the showerhead 100 or the faucet body 60.

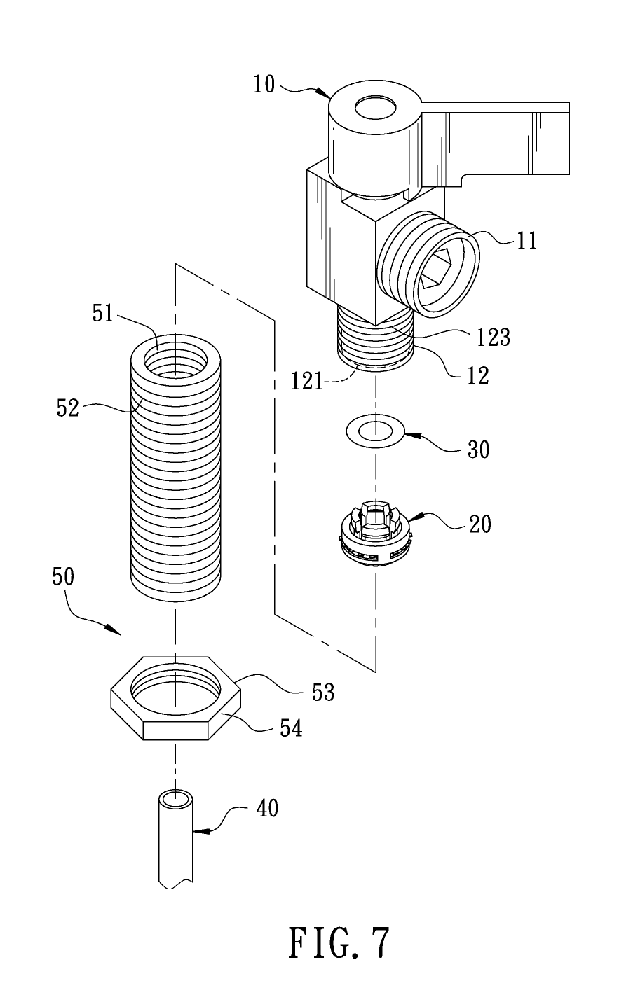

With reference to FIG. 7 shown as a partial 3D exploded perspective view of a single-handle washer machine valve according to this invention, a valve 10 is provided. Each of the two valves 10 is connected to a water outlet passage 11 and a water inlet passage 12. Threads 123 are formed at the outside of water inlet passage 12, and a concave joint slot 121 is formed in each of the water inlet passages 12 to wedge to a watertight unit 30 and a quick release joint unit 20. A water pipe 40 is provided and connected to the quick release joint units 20, while the other end of the water pipe 40 is connected to a water source. A joint unit 50 is provided, the inner sides of which are formed with inner threads 51 spirally adjoining the threads 123 of the water inlet passages 12. The outside of joint unit 50 is further formed with outer threads 52 and spirally connected to a blocking unit 53, a screw nut 54. With the joint unit 50, the faucet in the embodiment may be fixed to the washer machine.

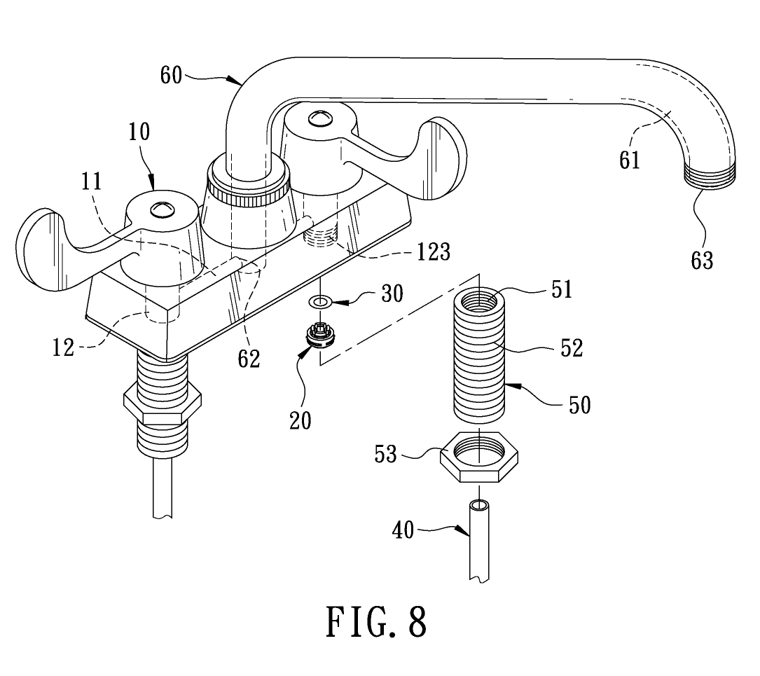

With reference to FIG. 8 shown as a partial 3D exploded perspective view of a laundry faucet with two wrist blade handles according to this invention, the faucet mainly comprises a faucet body 60. A gateway 61 is formed in the faucet body 60. A water inlet 62 and a water outlet 63 are formed at the outside of faucet body 60 that is opposite to two ends of the gateway 61. Two valves 10 are provided, each of which is connected to a water outlet passage 11 and a water inlet passage 12. The other end of each of the water outlet passage 11 is connected to each of the water inlet 62. Threads 123 are formed at the outside of water inlet passage 12. A watertight unit 30 and a quick release joint unit 20 are provided and wedged into the valve. Two water pipes 40 are provided that are respectively connected to the quick release joint units 20. The other end of each of the water pipes 40 is connected to a water source. The two joint units 50 are hollow pipes the inner sides of which are formed with inner threads 51 spirally adjoining the threads 123 of the water inlet passages 12. The outside of joint unit 50 is further formed with outer threads 52 and spirally connected to a blocking unit 53, a screw nut 54.

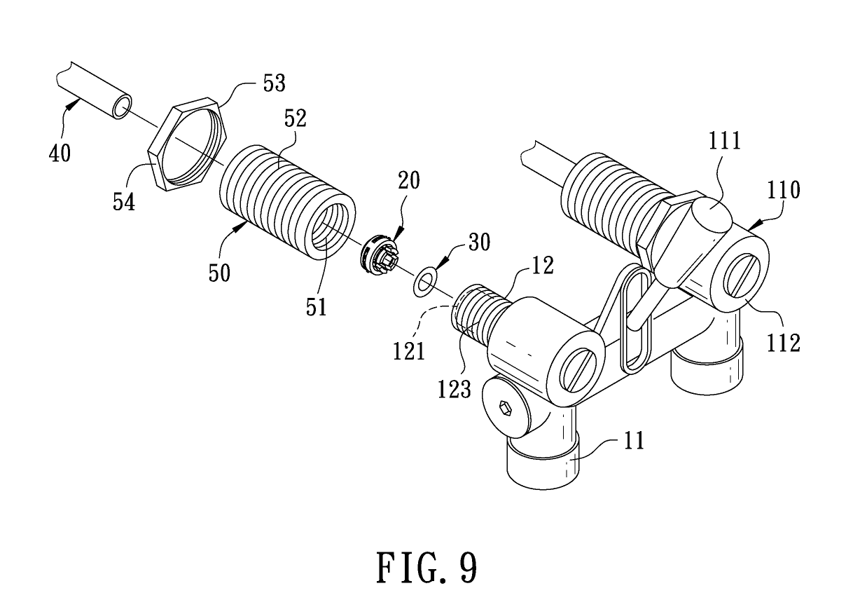

With reference to FIG. 9 shown as a partial 3D exploded view of a washing machine faucet with two single control valves according to this invention, the faucet mainly comprises a single control bi-valve device 110 for controlling hot water and cold water. A control rod 111 is provided in the middle portion of single control bi-valve device 110. The control rod 111 is a T-rod two opposite ends of which are connected to a water valve 112 so that the control rod 111 may simultaneously control the water valve 112. Each of the operation valves 112 is connected to a water outlet passage 11 and a water inlet passage 12. Threads 123 are formed at the outside of water inlet passage 12. A concave joint slot 121 is formed in each of the water inlet passages 12 to wedge to a watertight unit 30 and a quick release joint unit 20. Two water pipes 40 are provided and connected to the water inlet passages 12, while the other end of each of the water pipes 40 is connected to a water source. The two joint units 50 are hollow pipes the inner sides of which are formed with inner threads 51 spirally adjoining the threads 123 of the water inlet passages 12. The outside of joint unit 50 is further formed with outer threads 52 and spirally connected to a blocking unit 53, a screw nut 54.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A quick release device for faucets, mainly comprising:
a valve being connected to at least two passages through which water flows in and out, in which at least one passage is formed with a concavejoint slot the inner circumference of which is formed with a shift limit slot; and
a quick release joint unit being provided for quick release of a pipeline, in which a shift limit unit is provided around the outer circumference of quick release joint, the quick release joint unit is oppositely arranged in the joint slot and fixed oppositely in the shift limit slot.

2. The quick release device for faucets according to claim 1, wherein the faucet further comprises a watertight unit arranged between the joint slot and the quick release joint unit.

3. The quick release device for faucets according to claim 1, wherein the quick release joint unit comprises an outer ring and an inner clamping unit, the outer ring is set around the inner clamping unit, the clamping unit is provided around the outer circumference of outer ring, the inner clamping unit is a locking jaw provided with four chucks, a flange is provided at the outside of each of the chucks, several shift limit slices opposite to the flanges are formed at the inner sides of chucks, and a shift limit ring opposite to the flange is provided around the bottom side of locking jaw, thereby the outer ring being fixed for the flange.

4. The quick release device for faucets according to claim 3, wherein the clamping unit is provided where several protruding clamping slices are spaced at a distance of intervals around the outer circumference of outer ring.

5. The quick release device for faucets according to claim 1, wherein the outer circumference of the passage that is provided with the quick release joint unit is formed with threads and thus spirally connected to a joint unit the outer circumference of which id formed with a blocking unit.

6. The quick release device for faucets according to claim 1, wherein the faucet is provided with a valve connected to two water inlet passages and a water outlet passage, in which the quick release joint unit is provided in the water inlet passage.

7. The quick release device for faucets according to claim 1, wherein the faucet is provided with two valves respectively connected to a water outlet passage and a water inlet passage, in which the water outlet passages are connected to a faucet body and controlled by the valves to give water, and the water inlet passage is formed with the quick release joint unit.

8. The quick release device for faucets according to claim 7, wherein the faucet body is provided with a water inlet and a water outlet, in which the water inlet is connected to a t-joint provided with three junction ports, and the quick release joint unit is provided at each of the junction ports.
